(19) United States
(12) Patent Application Publication
(10) Pub. No.: US 2011/0021176 A1
(43) Pub. Date: Jan. 27, 2011

(54) ELECTRONIC INFORMATION DEVICE AND METHOD OF CONTROLLING THE SAME

(75) Inventor: Toshiaki Nakamura, Yokohama-shi (JP)

Correspondence Address: MORRISON & FOERSTER LLP, 12531 HIGH BLUFF DRIVE, SUITE 100, SAN DIEGO, CA, 92130-2040, US

(73) Assignee: Kyocera Corporation, Kyoto (JP)

(21) Appl. No.: 12/810,815

(22) PCT Filed: Dec. 26, 2008
(86) PCT No.: PCT/JP2008/073796

§ 371 Date: Sep. 16, 2010

(30) Foreign Application Priority Data
Dec. 27, 2007 (JP) 2007-335572

(51) Int. Cl. H04M 1/66

(52) U.S. Cl. 455/411

(57) ABSTRACT

Provided is a mobile telephone that performs a dial lock process for regulating some functions. The mobile telephone may include a personal identification code generating unit that generates a personal identification code for releasing the dial lock process when starting the dial lock process, and an outputting unit that outputs the personal identification code that is generated.

### TECHNICAL FIELD

The present invention relates to an electronic information device and method of controlling the same.

Priority is claimed on Japanese Patent Application No. 2007-335572, filed Dec. 27, 2007, the content of which is incorporated herein by reference.

### BACKGROUND ART

Recently, there is rapid progress in increasing the performance of electronic information devices such as mobile telephones, which have more advanced functions such as large-capacity telephone number storage and transmission/reception of e-mail. One consequence of these functional advancements is that a large quantity of personal data, including private information such as names, telephone numbers, and e-mail addresses of individuals, is stored in the memory of the mobile telephone. If a third party makes unauthorized use of this large quantity of personal data, there is an infringement of privacy. Therefore, means to prevent unauthorized use by a third party are required. As a means of preventing unauthorized use by a third party other than the owner, conventional mobile telephones are fitted with a dial lock function. A conventional dial lock function makes an open/close detection of the mobile telephone unit, and then executes a dial lock based on settings data stored beforehand. Also, a conventional dial lock function uses a timer or a clock function to set a time for dial lock and the time period (e.g. see Patent Literature 1).

### Patent Literature 1: Japanese Unexamined Patent Application No. 2004-343677

### DISCLOSURE OF INVENTION

### Problems to be Solved by the Invention

To release the dial lock function described above, a personal identification code set beforehand by the user must be inputted by manipulating the keys. However, if the same personal identification code is used every time, there is a high possibility that a third party will discover it and use it without authorization. To maintain security, the personal identification code must be changed as appropriate. Since this requires manipulation to set a new personal identification code, it is tiresome. Also, the more frequently the user changes his personal identification code, the more likely he is to forget his new personal identification code.

Due to the trouble entailed in resetting, many users hardly ever change their personal identification codes.

The present invention has been realized in view of these conventional technical problems. It is an object of the present invention to provide an electronic information device and a controlling method therefore which can increase the security of the electronic information device and enhance convenience.

### Means for Solving the Problems

An electronic information device executes a function restriction process that restricts part of functions of the electronic information device. The electronic information device may include a personal identification code generating unit that generates a personal identification code, the personal identification code releasing the function restriction process when starting the function restriction process.

The electronic information device may further include an outputting unit that outputs the personal identification code that is generated.

The personal identification code may be formed from a plurality of randomly selected numbers and symbols.

The personal identification code may be randomly selected from a plurality of personal identification codes that are set beforehand.

The electronic information device may further include a display unit that displays the personal identification code that is generated.

The electronic information device may further include a pronouncing unit that pronounces the personal identification code that is generated.

The outputting unit may include a communication unit, the outputting unit transmitting the personal identification code to another predetermined electronic information device.

The electronic information device may further include a storage unit that stores the personal identification code that is generated. The outputting unit transmits the personal identification code that is stored in the storage unit when the outputting unit receives a request for the personal identification code through the communication unit.

The electronic information device may further include a first detector that detects a first state and a second state of the electronic information device. The function restriction process is started based on an output of the first detector.

The electronic information device may further include a second detector that detects a vibration applied to the electronic information device. The function restriction process is started based on an output of the second detector.

The electronic information device may further include an input unit. The function restriction process is started when the input unit detects a predetermined input manipulation.

A method of controlling an electronic information device executing a function restriction process that restricts part of functions of the electronic information device may include generating a personal identification code that releases the function restriction process when starting the function restriction process, and outputting the personal identification code that is generated.

### Effect of the Invention

According to the present invention, since every time a function restriction process is executed, a personal identification code for releasing function restriction can easily be made different, there is less possibility that the personal identification code will become known to a third party, and security is increased. Since the personal identification code is generated automatically every time a function restriction process is executed, or selected arbitrarily from a plurality of preset personal identification codes, a tiresome input manipulation to change the personal identification code is unnecessary. Also, since the generated personal identification code is displayed on a display unit, or audibly pronounced by a pronouncing unit, the user can reliably recognize the personal identification code that changes every time.

Moreover, in the present invention, since the generated personal identification code can be transmitted in an e-mail to a preset e-mail address, if the user forgets his personal identification code, he can ascertain his personal identification code by checking that e-mail. If he cannot immediately check his e-mail due to a reason such as that he is not near a device which the e-mail was transmitted to, he can make a request for the personal identification code to the electronic information device of the present invention from another apparatus with a communication function.

Therefore, it is possible to provide an electronic information device with high security that can prevent unauthorized use by a third party and is highly convenient.

### BRIEF DESCRIPTION OF THE DRAWINGS

FIG. 1A is a perspective view illustrating an in-use state (open state) of a mobile telephone unit in accordance with a first preferred embodiment of the present invention.

FIG. 1B is a perspective view illustrating a stored state (closed state) of a mobile telephone unit in accordance with a first preferred embodiment of the present invention.

FIG. 2 is a block diagram illustrating a schematic configuration of a mobile telephone unit in accordance with a first preferred embodiment of the present invention.

FIG. 3 is a flowchart illustrating a controlling method of a mobile telephone unit in accordance with a first preferred embodiment of the present invention.

FIG. 4 is a perspective view illustrating a mobile telephone unit in accordance with a second preferred embodiment of the present invention.

FIG. 5 is a block diagram illustrating a schematic configuration of a mobile telephone unit in accordance with a second preferred embodiment of the present invention.

FIG. 6 is a flowchart illustrating a controlling method of a mobile telephone unit in accordance with a second preferred embodiment of the present invention.

### Reference Symbols

100 Mobile telephone unit in accordance with first preferred embodiment (Electronic information device)

100A Mobile telephone unit body (Electronic information device body)

1 First casing (Body member)

2 Second casing (Body member)

3 Hinge

4 Manipulation keys

5 Key input unit (Input manipulation unit)

6 Microphone

7 Projected part

8 Bearing part

9 Screen display unit

10 Speaker

11 Sub display unit

12 Antenna

19 Vibrating unit

20 Memory

20A Settings storage unit (Storage unit)

21 Wireless transmitting/receiving unit (Communication unit)

22 Signal processor

23 Pronouncing unit (Outputting units)

24 Open/close detection sensor (First detector)

25 E-mail transmitter (Outputting units)

26 Display unit (Outputting units)

27 Body controller

27A Key lock controller

27B Personal identification code generator (Personal identification code generating units)

200 Mobile telephone unit in accordance with second preferred embodiment

200A Mobile telephone unit body in accordance with second preferred embodiment (Electronic information device body)

201 Casing

202 Side key

203 Vibration detector (Second detector)

### BEST MODE FOR CARRYING OUT THE INVENTION

Preferred embodiments of the present invention will be explained with reference to the drawings. Unless otherwise stated, the dimensions, materials, shapes, relative arrangement, and the like of the constituent parts in these preferred embodiments are simply exemplary, and are not intended to limit the scope of the present invention.

### Embodiment 1

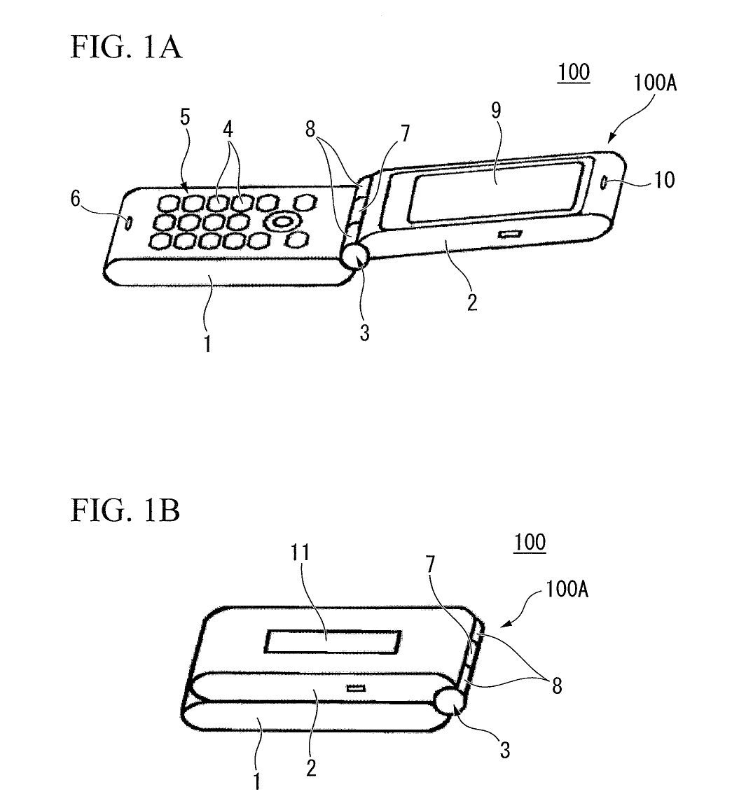

FIGS. 1A and 1B are explanatory views of the total configuration of a mobile telephone unit in accordance with the first preferred embodiment of the present invention.

FIG. 1A is a perspective view of an in-use state (open state) of a mobile telephone unit, and FIG. 1B is a perspective view of a stored state (closed state) of the mobile telephone unit.

A mobile telephone unit 100 (electronic information device) includes a mobile telephone unit body 100A (electronic information device body) formed by connecting a first casing 1 (body member), a second casing 2 (body member) via a hinge 3. The first casing 1 includes a key input unit 5 (manipulation input unit) in one face. The second casing 2 includes a screen display unit 9 in one face. The mobile telephone unit 100 (electronic information device) is folded and stored in a state where the screen display unit 9 and the key input unit 5 (manipulation input unit) are opposite each other with the first casing 1 and the second casing 2 overlapping each other. As illustrated in FIG. 1A, the mobile telephone unit 100 is usually used while it is open.

The hinge 3 includes a projected part 7 formed at an end part of the second casing 2, and a pair of bearing parts 8 formed at end parts of the first casing 1. The projected part 7 is disposed between the bearing parts 8. The hinge 3 uses a hinge pin (which is not illustrated in the figure) that extends through both bearing parts 8 and the projected part 7 to connect the first casing 1 and the second casing 2 such that they can rotate freely. As illustrated in FIG. 1A, a state where the angle between the first casing 1 and the second casing 2 is near to 180 degrees is deemed a manipulation state, i.e. an open state (first state). Whereas, as illustrated in FIG. 1B, a state where the angle between the first casing 1 and the second casing 2 is almost zero is deemed a folded state, i.e. a closed state (second state). In the open state, the angle between the first casing 1 and the second casing 2 is not limited to one that is near to 180 degrees.

As illustrated in FIG. 1A, in an inner face of the first casing 1 (the face that overlaps with the second casing 2), a microphone 6 for telephone transmission is disposed near an end part of the side opposite to the hinge 3. The key input unit 5 includes a plurality of manipulation keys 4 that can be pressingly manipulated, such as a conversation key, a call-end key, and numerical keys.

A speaker 10 for telephone reception is disposed in an inner face of the second casing 2 (the face that overlaps with the first casing 1) near an end part of the side opposite to the hinge 3. Also, as illustrated in FIG. 1B, a sub display unit 11 is disposed in an outer face of the second casing 2, i.e. in the face exposed to the outside when the mobile telephone unit 100 is in its closed state. The sub display unit 11 displays information such as the present time and date. In the first preferred embodiment of the present invention, the sub display unit 11 also displays a dial lock state or a lock release state and the like, which are explained later.

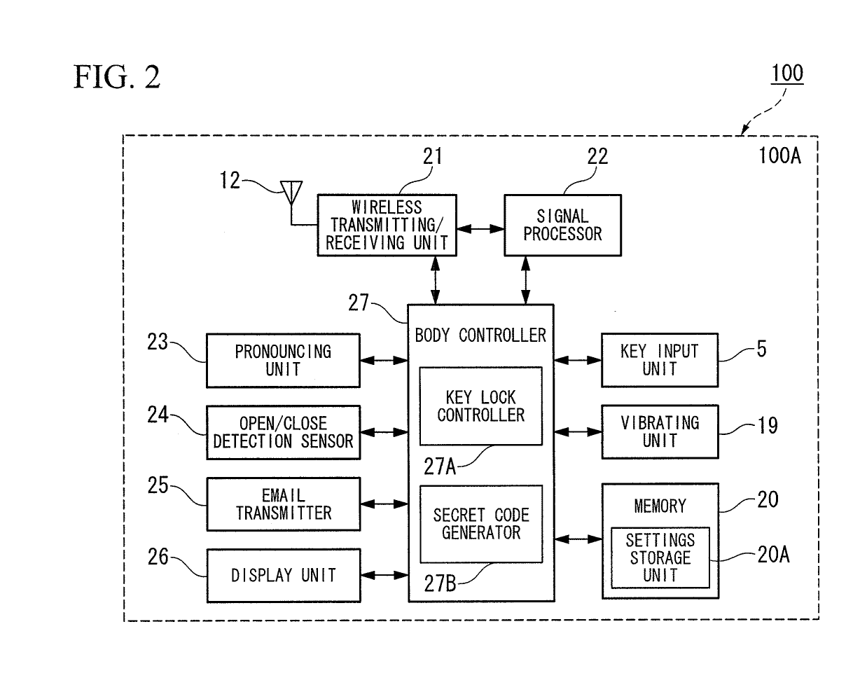

FIG. 2 is a block diagram illustrating a schematic configuration of the mobile telephone unit in accordance with the first preferred embodiment. In FIG. 2, members corresponding to those illustrated in FIG. 1 are represented by the same reference codes.

As illustrated in FIG. 2, the mobile telephone unit 100 of the first preferred embodiment of the present invention includes a key input unit 5, an antenna 12, a vibrating unit 19, a memory 20, a settings storage unit 20A (storage unit), a wireless transmitting/receiving unit 21 (communications unit), a signal processor 22, a pronouncing unit 23, an open/close detection sensor 24 (first detector), an e-mail transmitter 25, a display unit 26, a body controller 27, a key lock controller 27A, and a personal identification code generator 27B.

By controlling the various parts of the mobile telephone unit 100 illustrated in FIGS. 1A and 1B, the body controller 27 controls the main operations of the mobile telephone unit 100, such as setting various types of functions. The body controller 27 is connected to the wireless transmitting/receiving unit 21, the signal processor 22, the key input unit 5, the memory 20, the display unit 26, the pronouncing unit 23, the open/close detection sensor 24, and to the e-mail transmitter 25 which transmits e-mails to other apparatuses.

The open/close detection sensor 24 detects the open/close state of the mobile telephone unit 100, i.e. it detects whether the first casing 1 and the second casing 2 are in the open state (FIG. 1A) or the closed state (FIG. 1B). Various formats can be used for the open/close detection sensor 24. For example, a pair of switches (press switches, optical switches, magnetic sensors, etc.) or variable resistors that respectively detect an open state or a closed state can be used in detecting the open-close state of the first casing 1 and the second casing 2. The open/close detection sensor 24 can be disposed near the hinge 3, or on one of the mutually opposing face sides of the first casing 1 or the second casing 2, or elsewhere.

The body controller 27 controls all the parts of the mobile telephone unit 100 illustrated in FIGS. 1A and 1B, thereby collectively controlling the operations of the mobile telephone unit 100. The body controller 27 includes the key lock controller 27A having a function of restricting some of the functions of the mobile telephone unit 100 (dial lock function) and the personal identification code generator 27B that generates a personal identification code for releasing dial lock.

The key lock controller 27A detects the open/close state of the mobile telephone unit body 100A in accordance with the output from the open/close detection sensor 24. In the first preferred embodiment of the present invention, when the closed state of the mobile telephone unit body 100A is detected, a dial lock process is executed. During dial lock, the key lock controller 27A prohibits predetermined functions, e.g. operations other than receiving calls, and invalidates all inputs through manipulation of the key input unit 5 by a user, other than at least inputting a personal identification code for releasing dial lock.

The personal identification code generator 27B has a function of generating a personal identification code for releasing the dial lock. Under the control of the key lock controller 27A, a personal identification code including a character stream of several digits is generated. The personal identification code is formed from a plurality of randomly selected numbers and symbols. The personal identification code can be formed entirely from numbers or from symbols, or from a combination of both. The number of digits in the personal identification code is set appropriately, and is preferably not less than, for example, two digits. While a higher number of digits ensure greater security, the number of digits in the personal identification code is preferably small that will not be burdensome for the user who must memorize it.

The memory 20 stores various control programs executed by the body controller 27. The memory 20 also temporarily stores various types of control data used in the body controller 27. The memory 20 of the first preferred embodiment of the present invention contains a settings storage unit 20A that stores control data used in the key lock controller 27A and the personal identification code generator 27B. For example, the settings storage unit 20A stores the time taken from detecting a closed state of the mobile telephone unit body 100A to executing a dial lock, data relating to functions (applications) that are restricted during dial lock, personal identification codes generated by the personal identification code generator 27B, and the like.

The key input unit 5 includes the manipulation keys 4 illustrated in FIG. 1A. The key input unit 5 outputs the content of a manipulation of the manipulation keys 4 made by the user as a manipulation signal to the body controller 27.

The display unit 26 includes the screen display unit 9 illustrated in FIG. 1A and the sub display unit 11 illustrated in FIG. 1B. Based on a display control signal inputted from the body controller 27, the display unit 26 displays various messages, telephone numbers, images, etc. In the first preferred embodiment of the present invention, the display unit 26 displays an indication that the dial lock is ON or OFF, and the personal identification code that has been generated. The display time of a personal identification code in the sub display unit 11 can be set beforehand by the user.

The pronouncing unit 23 is connected to the speaker 10 illustrated in FIG. 1. Based on a pronouncing control signal outputted from the body controller 27, the pronouncing unit 23 generates a ringing tone, a mail received tone, an alarm tone, a manipulation confirmation tone, and electronic sounds corresponding to other settings. In the first preferred embodiment of the present invention, the pronouncing unit 23 has what is known as a reading function, whereby it uses electronic sounds to express a personal identification code generated in the personal identification code generator 27B. The matter of whether or not to implement this reading function is determined based on a setting made by the user beforehand. For example, when the pronouncing unit 23 notifies the user of a personal identification code, if there is a possibility that a third party is present near the user, the user can stop the personal identification code reading function beforehand, or set the personal identification code reading function to a volume that is only audible to himself. The reading function is preferably stopped during manner mode by the body controller 27.

The vibrating unit 19 becomes operational and makes the mobile telephone unit 100 vibrate if a control signal is outputted from the body controller 27. For example, the vibrating unit 19 notifies the user of incoming calls, received e-mails, alarms, etc.

The e-mail transmitter 25 transmits a personal identification code generated in the personal identification code generator 27B in an e-mail to an e-mail address set by the user beforehand. The e-mail address of the transmission destination is not the e-mail address unique to the mobile telephone unit 100; it is the e-mail address of another apparatus registered to the user's profile. For example, it is possible to use an e-mail address used on a personal computer belonging to the user.

The wireless transmitting/receiving unit 21 uses a predetermined communication method (e.g. CDMA method) to exchange wireless communications via the antenna 12 with a base station (which is not illustrated in the figure). The signal processor 22 processes sound data during a telephone conversation. The signal processor 22 is connected to the microphone 6 and the speaker 10 illustrated in FIG. 1A. Under the control of the body controller 27, the signal processor 22 performs a predetermined process to a received signal outputted from the wireless transmitting/receiving unit 21, and outputs it to the speaker 10. The signal processor 22 also performs a predetermined process to an audio signal inputted from the microphone 6, and outputs the audio signal to the wireless transmitting/receiving unit 21.

### Method of Controlling Mobile Telephone Unit

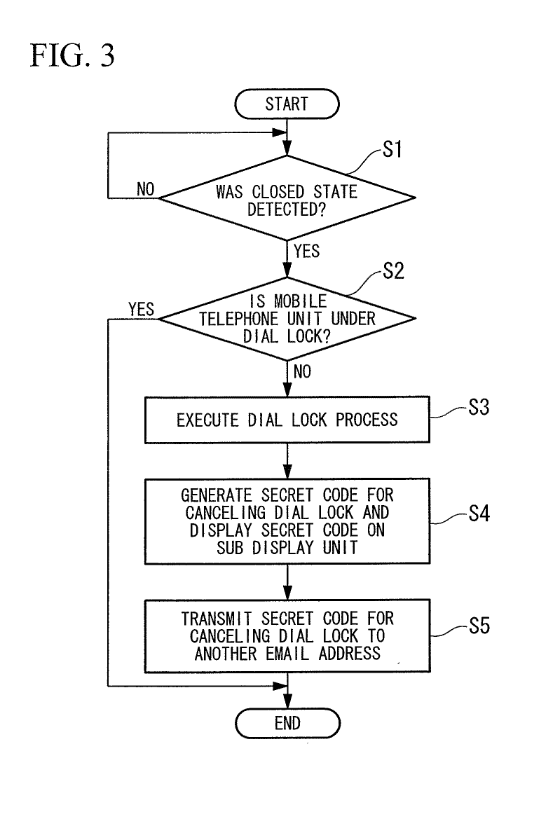

FIG. 3 is a flowchart illustrating a method of controlling the mobile telephone unit in accordance with the first preferred embodiment of the present invention. The processes of the flowchart illustrated in FIG. 3 will start when an open/close manipulation is performed to the mobile telephone unit.

The key lock controller 27A determines whether or not the mobile telephone unit 100 has been changed to the closed state (Step S1). If the key lock controller 27A determines, based on the output from the open/close detection sensor 24, that the mobile telephone unit 100 is in the closed state, then the key lock controller 27A determines whether or not the mobile telephone unit 100 is in a dial lock state (Step S2). If the determination result is YES, that is, if the mobile telephone unit 100 is in the dial lock state, then the key lock controller 27A ends this process, since the dial lock continues unaltered.

On the other hand, if the determination result in Step S2 is NO, that is, if the mobile telephone unit 100 is not in the dial lock state, then the key lock controller 27A decides to execute a dial lock process, and executes the dial lock process based on conditions set by the user beforehand (Step S3). For example, the user selects a dial lock function setting from a predetermined menu screen, and selects the time from determining the closed state of the mobile telephone unit 100 to executing the dial lock process, the functions (applications) to be restricted, and so on, beforehand.

When the key lock controller 27A executes the dial lock process, the personal identification code generator 27B generates a personal identification code for releasing dial lock (Step S4). The personal identification code generator 27B generates a personal identification code of several digits formed from a plurality of randomly selected numbers and symbols. The personal identification code generator 27B generates a new personal identification code every time a dial lock process is executed, and is set so that it does not consecutively generate the same personal identification code. When a personal identification code, which has been generated when the previous dial lock process was executed, is stored in the settings storage unit 20A, the personal identification code (a personal identification code that has already been used once in dial lock release) is deleted and a new personal identification code is written. Alternatively, a personal identification code stored in the settings storage unit 20A can be deleted after the personal identification code has been used once to release the dial lock.

In Step S4, at the same time that the personal identification code generator 27B generates the personal identification code, the personal identification code generator 27B outputs the personal identification code to the display unit 26 as a display control signal. The display unit 26 displays the personal identification code on the sub display unit 11 for a predetermined time or at predetermined intervals. In this manner, the generated personal identification code is reported to the user.

The mobile telephone unit 100 transmits the generated personal identification code in an e-mail to an e-mail address that the user set beforehand (Step S5). At this time, the body controller 27 reads the personal identification code stored in the settings storage unit 20A and outputs the personal identification code to the e-mail transmitter 25. The e-mail transmitter 25 transmits an e-mail containing the personal identification code, and thereby reports the personal identification code that has been generated during dial lock to the user. The address of the transmission destination of the e-mail is one that the user set beforehand, it being possible for the user to set one or a plurality of e-mail addresses.

### Method for Releasing Dial Lock

Next, a process for releasing the dial lock function will be described. If the key lock controller 27A determines that the mobile telephone unit 100 is in the open state (Step S1 in FIG. 3), then the key lock controller 27A determines whether or not the mobile telephone unit 100 is in the dial lock state. If the mobile telephone unit 100 is in the dial lock state (Step S2 in FIG. 3), then the mobile telephone unit 100 waits for the user to input a personal identification code.

If a personal identification code is inputted by a manipulation of the manipulation keys 4, then the key lock controller 27A determines whether or not this personal identification code matches one stored in the settings storage unit 20A. If the inputted personal identification code is authenticated, then the key lock controller 27A releases the dial lock.

The flowchart described above is merely one example of a controlling method, and should not be regarded as limitative.

Thus the mobile telephone unit 100 in accordance with the first preferred embodiment of the present invention automatically generates a personal identification code to release the dial lock process. Since a different personal identification code is generated every time a dial lock process is executed, there is little possibility that the personal identification code will be leaked to a third party. Therefore, the security is greatly superior to a conventional electronic information device. For example, even if a third party observes the movement of the fingers of the user as he inputs the personal identification code, a personal identification code that has been used once to release a dial lock cannot be used to release a subsequent dial lock. This makes it possible to prevent unauthorized use by a third party.

In the first preferred embodiment of the present invention, since a generated personal identification code can be transmitted to an e-mail address of another apparatus, even if the user forgets his personal identification code, he can confirm a personal identification code for release. Thus it is possible to provide a mobile telephone unit with high security and enhanced convenience.

In the first preferred embodiment of the present invention, the mobile telephone unit 100 can receive an inquiry for a personal identification code from a user via the wireless transmitting/receiving unit 21, and can output a personal identification code stored in the settings storage unit 20A. To confirm that the person who sent the inquiry for a personal identification code is the user of the mobile telephone unit 100, the body controller 27 requests the conservation partner to input a secret number that the user set beforehand. If the body controller 27 determines that the secret number inputted through the key input unit 5 is correct, then it outputs a personal identification code for releasing dial lock.

Consequently, even if the user is unable to confirm the personal identification code for releasing dial lock due to his not being near the apparatus which the e-mail from the mobile telephone unit 100 was transmitted (e.g. when he is outside), he can confirm the personal identification code by placing a call to the mobile telephone unit 100 from a public telephone or the like. Therefore, even if the user forgets the personal identification code while he is outside, this problem can be speedily resolved.

### Second Embodiment

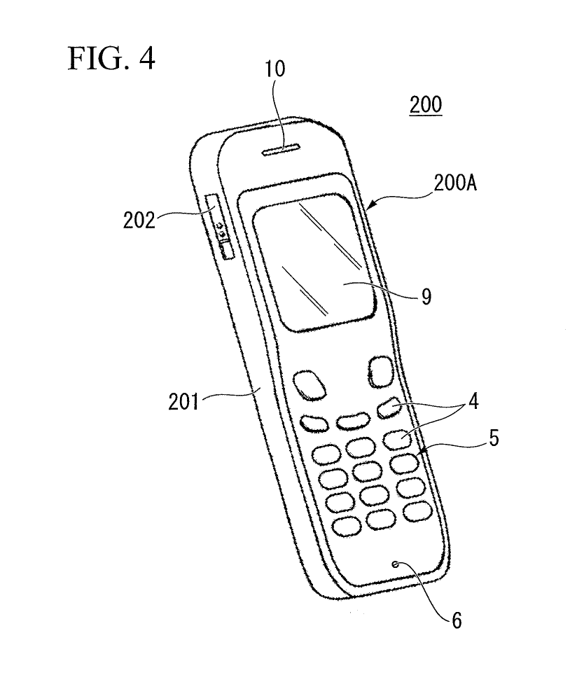

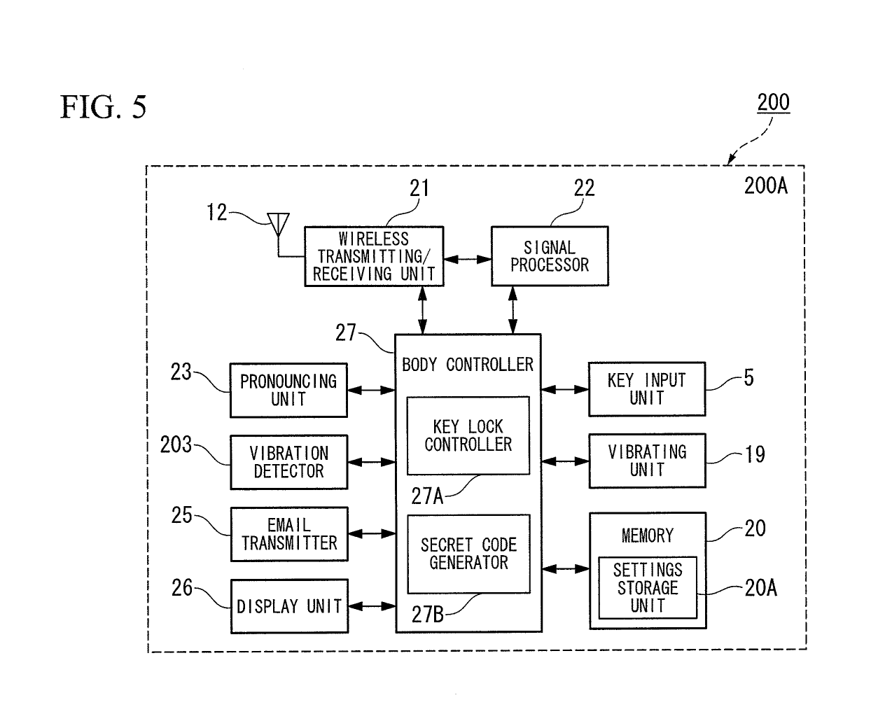

FIG. 4 is an explanatory perspective view illustrating an overall configuration of a mobile telephone unit in accordance with the second preferred embodiment of the present invention. FIG. 5 is a block diagram illustrating a schematic configuration of a mobile telephone unit in accordance with the second preferred embodiment of the present invention.

A mobile telephone unit 200 (electronic information device) in accordance with the second preferred embodiment of the present invention is a straight-type mobile telephone which does not have a folding structure. A casing 201 of the mobile telephone unit 200 includes a key input unit 5 and a screen display unit 9 within the same face. The casing 201 also includes a receiver speaker 10 and a microphone 6 for transmitting, at the top end and the bottom end of the face where the key input unit 5 and the screen display unit 9 are disposed.

The key input unit 5 in accordance with the second preferred embodiment of the present invention further includes a side key 202 arranged on a side face of the casing 201. The side key 202 can slide in the long direction of the casing 201, and is configured such that, after moving from an initial position to an end position, it always returns to the initial position. For example, if the user presses the side key 202 while moving it from its initial position to its end position and thereafter removes his finger from the side key 202, then the side key 202 will returns to its initial position by a restoring applied by a member (which is not illustrated in the figure).

The side key 202 has a switching function of selecting whether to execute a dial lock process of the mobile telephone unit 200. Every time a manipulation by the user moves the side key 202 to its end position, the ON and OFF for executing the dial lock process is switched. The setting of this switch is controlled by a body controller 27 illustrated in FIG. 5. If the body controller 27 detects, based on an output from the key input unit 5, that the side key 202 illustrated in FIG. 4 has been manipulated by the user, then the body controller 27 switches the ON and OFF of the side key 202. If the side key 202 is ON, then the body controller 27 permits execution of the dial lock process. On the other hand, if the side key 202 is OFF, then the body controller 27 does not execute the dial lock process.

The side key 202 need not be a sliding-type key, and may instead be a press-type key that can be moved inside the casing 201. In this case, the configuration is preferably one where the key returns to its original position when the user stops pressing the key.

As illustrated in FIG. 5, the body controller 27 in accordance with the second preferred embodiment of the present invention is connected to a vibration detector 203 (second detector) that detects a predetermined vibration applied to a mobile telephone unit body 200A. The vibration detector 203 uses an acceleration sensor or the like to detect vibrations other than those generated by the vibrating unit 19. The vibration detector 203 also generates vibrations other than those generated during ordinary usage (e.g. when creating an e-mail) and during ordinary standby (e.g. when the user walks with the mobile telephone unit 200 in his pocket). The vibration detector 203 detects vibrations that are greater than a predetermined cycle or predetermined amplitude, that is, vibrations generated when the mobile telephone unit 200 is intentionally shaken by the user.

Preferably, the acceleration sensor that is used is one that detects acceleration in three axis directions. Since a significant signal is outputted from the acceleration sensor whichever direction the user shakes the mobile telephone unit 200 in, the mobile telephone unit 200 has superior responsively.

If there is a possibility that the user will execute a dial lock after using the mobile telephone unit 200, then the user always keeps the side key 202 in the ON state. Thus, after using the mobile telephone unit 200, the user can execute the dial lock by shaking the mobile telephone unit body 200A.

### Method of Controlling Mobile Telephone Unit

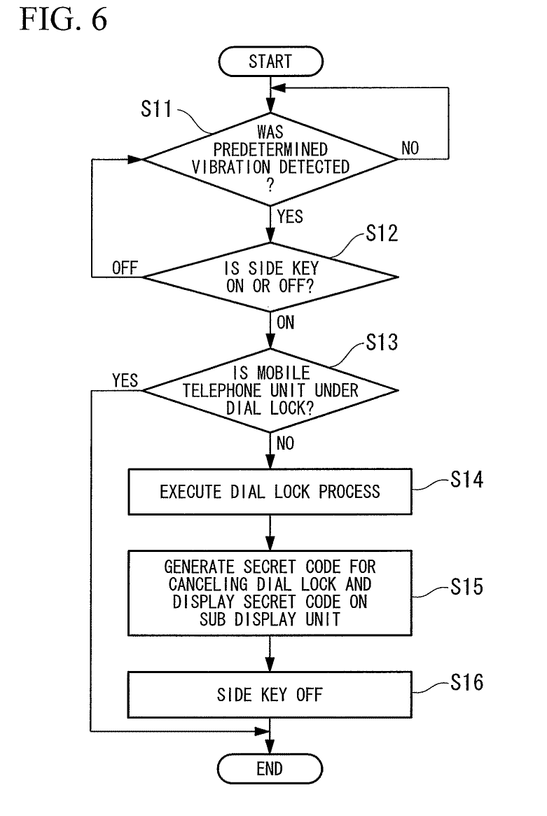

FIG. 6 is a flowchart illustrating a method of controlling a mobile telephone unit in accordance with the second preferred embodiment of the present invention. The processes in the flowchart of FIG. 6 are executed when, for example, the side key of the mobile telephone unit has been manipulated by the user.

If the vibration detector 203 detects that the vibration of the mobile telephone unit body 200A is a predetermined vibration greater than a preset cycle or vibration (when it determines YES), then the vibration detector 203 transmits a detection signal of that vibration to the body controller 27. Based on the detection signal from the vibration detector 203, the body controller 27 determines that the user intentionally shook the mobile telephone unit body 200A (Step S11).

The body controller 27 detects, in accordance with an output from the key input unit 5, that the side key 202 was manipulated by the user, and determines whether the side key 202 is ON or OFF (Step S12). In Step S12, if the side key 202 is manipulated while the mobile telephone unit 200 is under dial lock, the body controller 27 determines that the memory 20 has been switched ON. On the other hand, if the user manipulates the side key 202 again while the side key 202 is in the ON state, then the body controller 27 determines that the side key 202 has been switched OFF.

If the side key 202 is in the ON state when the vibration detector 203 detects the vibration of the mobile telephone unit body 200A, then the body controller 27 determines whether or not the mobile telephone unit 200 is under dial lock (Step S13). If it is confirmed that the mobile telephone unit 200 is not under dial lock (when the determination result is NO), then the key lock controller 27A executes a dial lock process (Step S14).

If the side key 202 was under dial lock when the vibration detector 203 detected the vibration of the mobile telephone unit body 200A (when the determination result in Step S13 is YES), then processing is made end.

If the key lock controller 27A executes a dial lock process (Step S14), then the personal identification code generator 27B generates a personal identification code for releasing dial lock (Step S15). The personal identification code generator 27B generates a personal identification code formed from a plurality of randomly selected numbers and symbols. The personal identification code generator 27B generates a personal identification code every time the key lock controller 27A executes a dial lock process. Furthermore, the personal identification code generator 27B outputs the generated personal identification code as a display control signal to the display unit 26, where the personal identification code is displayed for a predetermined time or at predetermined intervals.

Thereafter, the body controller 27 switches the side key 202 to OFF (Step S16). Thus the series of processes ends.

In the second preferred embodiment of the present invention, the personal identification code can also be transmitted in an e-mail to a preset e-mail address.

Thus, if the user shakes the mobile telephone unit body 200A while the mobile telephone unit 200 is not under dial lock and the side key 202 is in the ON state, then the body controller 27 executes a dial lock process, and generates a personal identification code for releasing dial lock.

Incidentally, the flowchart described above is merely one example of a control process and is not limitative.

The second preferred embodiment of the present invention can obtain advantageous effects similar to those of the first preferred embodiment of the present invention. That is, since the mobile telephone unit 200 automatically generates a personal identification code every time a dial lock process is executed, unauthorized use by a third party can be prevented. Furthermore, in the second preferred embodiment of the present invention, since a dial lock can be executed just by the user shaking the mobile telephone unit body 200A, even if the mobile telephone unit 200 is a straight type, the mobile telephone unit 200 can easily be subjected to a dial lock without a tiresome manipulation of the key input unit 5.

While preferred embodiments of the present invention have been described above while referring to the accompanying drawings, it should be understood that these are exemplary and are not to be considered as limitative. Various modifications and amendments within the technical field of the patent claims can be made by one of ordinary skill in the art, which is of course understood to belong to the technical field of the present invention.

For example, while the personal identification code generator 27B described in the preferred embodiments generates a personal identification code formed from a plurality of randomly selected numbers and symbols, the personal identification code generator 27B can appropriately select one of a plurality of personal identification codes that were stored by the user beforehand. The plurality of personal identification codes are formed from numbers and symbols selected arbitrarily by the user. The plurality of personal identification codes are stored in the settings storage unit 20A, and the personal identification code generator 27B selects a different personal identification code every time a dial lock process is executed.

Since one personal identification code can thereby be selected each time from among a plurality of personal identification codes prepared by the user beforehand, the possibility that the user will forget the selected personal identification code can be reduced.

Further, while the above preferred embodiments describe examples where the mobile telephone unit is a folding type as illustrated in FIG. 1, this is not limitative of the present invention, which can also be applied in a rotating-type mobile telephone unit wherein the first casing and the second casing are connected by a hinge that enables them to rotate, a sliding-type mobile telephone unit wherein a heart cam mechanism enables the first casing and the second casing to slide, and the like. In a rotating-type mobile telephone unit, the stored closed state is one where the first casing and the second casing overlap in the thick direction, and the exploded open state is one where one of the casings is rotated in one direction with respect to the other within the plane that they overlap in. In a sliding-type mobile telephone unit, the stored closed state is one where the first casing and the second casing overlap in the thick direction, and the exploded open state is one where one of the casings has been slid with respect to the other within the plane that they overlap in.

The present invention can also be applied in a flip-type mobile telephone unit wherein a cover is connected to the casings.

Furthermore, while in the preferred embodiments described above, one part of the input manipulation of the key input unit 5 is restricted, some of the functions and applications can also be restricted, such as the ability to view a list of telephone numbers.

### INDUSTRIAL APPLICABILITY

While the foregoing embodiments describe an example where the electronic information device is applied in a mobile telephone unit, it can also be applied in a personal handy phone system (PHS), a personal digital assistant (PDA), a game unit, etc.

1. An electronic information device executing a function restriction process that restricts part of functions of the electronic information device, the electronic information device comprising:
a personal identification code generating unit that generates a personal identification code, the personal identification code releasing the function restriction process when starting the function restriction process.

2. The electronic information device according to claim 1, further comprising:
an outputting unit that outputs the personal identification code that is generated.

3. A method of controlling the electronic information device according to claim 1, wherein the personal identification code is formed from a plurality of randomly selected numbers and symbols.

4. A method of controlling the electronic information device according to claim 1, wherein the personal identification code is randomly selected from a plurality of personal identification codes that are set beforehand.

5. The electronic information device according to claim 1, further comprising:
a display unit that displays the personal identification code that is generated.

6. The electronic information device according to claim 1, further comprising:
a pronouncing unit that pronounces the personal identification code that is generated.

7. The electronic information device according to claim 2, wherein the outputting unit comprises a communication unit, the outputting unit transmitting the personal identification code to another predetermined electronic information device.

8. The electronic information device according to claim 7, further comprising:
a storage unit that stores the personal identification code that is generated, and
wherein the outputting unit transmits the personal identification code that is stored in the storage unit when the outputting unit receives a request for the personal identification code through the communication unit.

9. The electronic information device according to claim 1, further comprising:
a first detector that detects a first state and a second state of the electronic information device, and
wherein the function restriction process is started based on an output of the first detector.

10. The electronic information device according to claim 1, further comprising:
a second detector that detects a vibration applied to the electronic information device, and
wherein the function restriction process is started based on an output of the second detector.

11. The electronic information device according to claim 1, further comprising an input unit, and wherein the function restriction process is started when the input unit detects a predetermined input manipulation.

12. A method of controlling an electronic information device executing a function restriction process that restricts part of functions of the electronic information device comprising:
generating a personal identification code that releases the function restriction process when starting the function restriction process; and
outputting the personal identification code that is generated.
